(19) United States
(12) Patent Application Publication
(10) Pub. No.: US 2014/0050277 A1
(43) Pub. Date: Feb. 20, 2014

(54) METHOD AND APPARATUS FOR SELECTING MULTI-USER PAIRING IN A MULTI-USER MULTI-INPUT MULTI-OUTPUT SYSTEM

(71) Applicant: FUJITSU LIMITED, Kawasaki-shi (JP)

(72) Inventors: Bingyang WU, Beijing (CN); Yu JIANG, Beijing (CN); Yi WANG, Beijing (CN); Hua ZHOU, Beijing (CN)

(73) Assignee: FUJITSU LIMITED, Kawasaki-shi (JP)

(21) Appl. No.: 14/062,395

(22) Filed: Oct. 24, 2013

Related U.S. Application Data
(63) Continuation of application No. PCT/CN2011/073532, filed on Apr. 29, 2011.

(51) Int. Cl. H04B 7/04; H04B 7/06

(52) U.S. Cl. CPC H04B 7/0452; H04B 7/0639
USPC 375/267

(57) ABSTRACT

The method includes calculating by user equipment an SINR of each of precoding vectors in a precoding matrix; whether there is an SINR greater than a first threshold in the SINRs of the precoding vectors; selecting by the user equipment a precoding vector to which the SINR greater than the first predetermined threshold corresponds according to a predefined policy; and feeding back by the user equipment to a base station a PMI of the selected precoding vector and a quantified value of the corresponding SINR, or feeding back by the user equipment to a base station a PMI of the selected precoding vector, a quantified value of the corresponding SINR and a number of times of transformation to which the SINR corresponds, or feeding back by the user equipment to a base station only a number of times of transformation.

### CROSS-REFERENCE TO RELATED APPLICATIONS

This application is a continuation of International Application No. PCT/CN2011/073532, filed on Apr. 29, 2011 and designating the U.S., the entire contents of which are incorporated herein by reference.

### TECHNICAL FIELD

The present invention relates to the field of communications, and in particular to a method and apparatus for selecting multi-user pairing in a multi-user multi-input multi-output (MU-MIMO) system.

### BACKGROUND ART

In a future mobile communication system, how to realize high-speed reliable data transmission by using limited radio spectrum resources is one of the key issues needing to be solved. Multi-input multi-output (MIMO) technology outstandingly improves the transmission rate of the system and the reliability of the link without increasing the bandwidth of the system, and has become one of the key technologies of the next generation mobile communication system. A point to multi-point MU-MIMO system is able to use a space division multiple access (SDMA) technology to transmit data to multiple users in the same time-domain resource, thereby greatly improving the capacity of the system and the spectrum efficiency. The MIMO technology has become a hot spot of research for LTE and LTE advanced. In a downlink of an MU-MIMO system, as various user cannot coordinate, the multi-user detection technology cannot be used to avoid the inter-user interference. The transmission end uses acquired channel information to precode transmission signals, and may effectively suppress the inter-user co-channel interference, thereby improving the transmission rate and reliability of the system, lowering the complexity of the receiver, and solving the problem of power consumption of the mobile station.

When the transmission end has the knowledge of channel state information at transmitter (CSIT), the system capacity of MIMO BC (Document [2]) may be reached by using dirty paper coding (DPC) (Document [1]). However, the realization of the DPC is very complex and hence, some suboptimal linear and nonlinear precoding schemes have been proposed. Common nonlinear precoding schemes based on ideal CSIT comprise Tomlinson-Harashima precoding (THP) (Documents [3] and [4]), and vector perturbation precoding (Documents [5] and [6]), etc. As nonlinear precoding is high in complexity and is difficult in realization, linear precoding has been widely studied. Some linear precoding schemes based on ideal CSIT comprise ZF (zero-forcing, channel inverse)) (Documents [7] and [8]), MMSE (minimum mean square error, regularized channel inverse) (Documents [8] and [9]), and block diagonalization (BD) (Documents [10] and [11]), etc. Wherein, ZF uses pseudo inverse of a channel matrix as a precoding matrix, which may completely eliminate inter-user interference and inter-data interference in a user, with the cost of needing relatively large transmission power to eliminate the interference. When a base station transmit one path of data streams to each user, the inter-user matrixes are degraded into vectors, and at this moment, this precoding scheme is also referred to as a zero-forcing beamforming (ZFBF). When there are a relatively large number of users in a system, the ZFBF scheme may obtain relatively good performance. However, if there are a relatively small number of users in a system or the SNR (Signal-to-Noise Ratio) is relatively low, its performance is relatively poor. A precoding matrix is designed in MMSE precoding, with the object being to minimize the MSE between transmission and receiving signals. In this scheme, a certain degree of receiving end interference is reserved in performing preprocessing at the transmission end, with the rate performance being better than ZF precoding. BD precoding configures multiple receiving antennas for multiple users and improves the ZF precoding scheme. Such a scheme eliminates only inter-user interference in performing preprocessing on transmitting signal, while the interference between data streams within a user is left to be processed by receivers of each user.

In a practical wireless communication system, CSIT is usually acquired in following two ways (Document [12]): for a TDD (time division duplexing) system, channel information of a downlink is usually inferred by using reciprocity of uplink and downlink channels according to uplink channel information estimated when the base station is taken as a receiving end; and for an FDD (frequency division duplexing) system, a user usually feeds estimated downlink channel information back to the base station via channels. Due to errors brought about by system channel estimation, quantization and feedback delay, it is hard for the transmission end to obtain ideal CSI. Therefore, research on precoding technology based on limited feedback is more significant practically meaningful.

In recent years, some precoding schemes based on limited feedback in an MU-MIMO system have been proposed, which are mainly divided into two types (Document [13]): a precoding technology based on channel vector quantization (CVQ) and a precoding technology based on projection.

In the precoding scheme based on CVQ, each user quantizes its channel information based on a predefined channel codebook, and then feeds the quantified channel information back to the base station. And the base station designs the precoding matrix based on a certain criteria (such as ZF, and MMSE) according to such information. In a case of non-ideal CSIT, the precoding scheme based on CVQ usually takes the channel information acquired by the base station as an actual channel, and base upon this, the precoding scheme designed on the assumption that the CSIT is ideal is applied. Such a method is sensitive to inaccurate CSI brought about by low-rate feedback and hence, the performance is poor.

In the precoding technology based on projection, a precoding codebook is used, and the precoding matrix is limited within a limited number of selections, including orthogonal random beamforming (ORBF) (Document [14]) and Per User Unitary Rate Control (PU2RC) (Documents [15] and [16]), which are designed in combination with user selections. Wherein, the ORBF scheme adopts a group of randomly-generated standard orthogonal vectors as a precoding codebook. Based on such a codebook, each user reports labels of its optimal beamforming vectors and corresponding SINR to the base station, and after receiving feedback information from all the users, the base station selects a user set making the system and the rate maximum for parallel data transmission. For further improving the system performance, PU2RC (per user unitary rate control) spreads the ORBF scheme, and uses multiple groups of randomly-generated standard orthogonal vectors as the precoding codebooks. PU2RC has become a basic implementation scheme of MU-MIMO in the 3GPP-LTE standard as it is able to obtain better performance with relatively low feedback rate. However, as the precoding vectors of PU2RC are limited within a predefined codebook, when the number of users is relatively small, the probability to find users selecting codebooks orthogonal to each other is relatively low, making the selected users unable to be matched with defined codebooks, and limiting the performance of the system. Some methods for improving PU2RC have been proposed, which are divided mainly into two types (Document [17]): one type is to improve codebooks by effectively developing channel information, and the other is to adaptively calculate codebooks.

Documents advantageous to the understanding of the present invention and the conventional technologies are listed below, which are incorporated herein by reference, as they are fully described herein.

### DOCUMENTS

[1] M. Costa, “Writing on dirty paper,” IEEE Trans. Inform. Theory, vol. 29, no. 3, pp. 439-441, May 1983.
[2] H. Weingarten, Y. Steinberg and S. Shamai. “The capacity region of the Guassian MIMO broadcast channel,” in Proc. IEEE Int. Symp. Inform. Theory (ISIT), Chicago, Ill., June/July 2004, p. 174.
[3] H. Harashima and H. Miyakawa, “Matched-transmission technique for channels with intersymbol interference,” IEEE Trans. Commun., pp. 774-780, August 1972.
[4] M. Tomlinson, “New automatic equalizer employing modulo arithmetic,” IEEE. Lett., pp. 138-139, March 1971.
[5] B. M. Hochward, C. B. Peel, and A. L. Swindlehurst, “A vector perturbation technique for near capacity multiantennas multiuser communication-part II: perturbation,” IEEE Trans. Comm., vol. 52, pp. 537-544, March 2005.
[6] C. Windpassingger, R. F. H. Fischer, and J. B. Huber, “Lattice-reduction-aided broadcast precoding,” IEEE Trans. Commun., vol. 52, no. 12, pp. 2057-2060, December 2004.
[7] G. Caire and S. Shamai, “On the achievable throughout of a multi-antenna Guassian broadcast channel,” IEEE Trans. Info. Theory., vol. 44, pp. 1691-1706, July 2003.
[8] B. M. Hochward, C. B. Peel, and A. L. Swindlehurst, “A vector perturbation technique for near capacity multiantennas multiuser communication-part I: Channel inverse and regularization,” IEEE Trans. Comm., vol. 52, pp. 195-202, March 2005.
[9] M. Joham, W. Utschick, and J. A. Nossek. “Linear transmit processing in MIMO communication systems,” IEEE Trans. Signal process., vol. 53, no. 8, pp. 2700-2712, August 2005.
[10] H. Spencer, A. L. Swindlehurst, and M. Haardt, “Zero-forcing methods for downlink spatial multiplexing in multiuser MIMO channels,” IEEE Trans. Signal Processing, vol. 52, no. 2, February 2004, pp. 461-471.
[11] L. U. Choi and R. D. Murch, “A transmit preprocessing technique for multiuser MIMO systems using a decomposition approach,” IEEE Trans. Wireless Commun., vol. 3, no. I, January 2004, pp. 20-24.
[12] M. Vu and A. PAulraj, “MIMO wireless linear precoding,” IEEE Signal Process. Mag., vol. 24, no. 5, pp. 86-105, September 2007.
[13] D. J. Love, R. W. Heath, V. Lau, D. Gesbert, B. D. Rao and M. Andrews, “An Overview of limited feedback in wireless communication systems,” IEEE J. Sel. Areas Commun, vol. 26, no. 8, pp. 1341-1365, October 2008.
[14] M. Sharif, and B. Hassibi, “On the Capacity of MIMO broadcast Channels with Partial Side Information,” IEEE Trans. Inf. Theory, vol. 51, no. 2, pp. 506-522, February 2005.
[15] Samsung Electronics, Downlink MIMO for EUTRA, February 2006. 3GPP TSG RAN WG1 44/R1-060335.
[16] K. Huang, J. G. Andrew, and R. W. Heath, “Performance of orthogonal beamforming for SDMA with limited feedback,” IEEE Trans. Veh. Technol., vol. 58, no. 1, pp. 152-164, January 2009.
[17] H. Lee, I. Sohn and K. B. Lee, “Low-Feedback-Rate and Low-Complexity Downlink Multiuser MIMO Systems,” IEEE. Veh. Technol., vol. 59. no. 7, pp 3640-3645, September, 2010.

It should be noted that the above description of the background art is merely provided for clear and complete explanation of the present invention and for easy understanding by those skilled in the art. And it should not be understood that the above technical solution is known to those skilled in the art as it is described in the background art of the present invention.

### SUMMARY OF THE INVENTION

An object of the embodiments of the present invention is to provide a method and apparatus for selecting multi-user pairing in an MU-MIMO system, so as to improve the performance of a base station in selecting multi-user pairing when the number of users is relatively small or the SINR is relatively low.

According to an aspect of the embodiments of the present invention, there is provided a method for selecting multi-user pairing in an MU-MIMO system, comprising:

a calculating step: calculating by user equipment an SINR (signal to interference plus noise ratio) of each of precoding vectors in a precoding matrix;

a selecting step: selecting by the user equipment a precoding vector to which an SINR greater than a first predetermined threshold corresponds according to the calculated SINR of each of the precoding vectors; and

a feeding back step: feeding back by the user equipment to a base station a PMI (precoding matrix indicator) of the selected precoding vector and a quantified value of the corresponding SINR, or feeding back by the user equipment to a base station a PMI of the selected precoding vector, a quantified value of the corresponding SINR and a number of times of transformation to which the SINR corresponds, or feeding back by the user equipment to a base station a number of times of transformation to which the SINR corresponds.

According to another aspect of the embodiments of the present invention, there is provided a method for selecting multi-user pairing in an MU-MIMO system, comprising:

a receiving step: receiving by a base station information fed back by a plurality of users, the information fed back by the plurality of users including: a PMI of a precoding vector and a quantified value of the SINR of the precoding vector for each user, or a PMI of a precoding vector, a quantified value of the SINR of the precoding vector and information about a number of times of transformation to which the SINR corresponds for each user, or the number of times of transformation of the precoding matrix for each user; and

a selecting step: selecting by the base station, according to the information fed back by the plurality of users, a predetermined number of users who perform the same number of times of transformation on the original precoding matrix and satisfy user pairing conditions, as selected users.

According to a further aspect of the embodiments of the present invention, there is provided user equipment, comprising:

a calculating unit configured to calculate an SINR of each of precoding vectors in a precoding matrix;

a selecting unit configured to select a precoding vector to which an SINR greater than a first predetermined threshold corresponds according to the calculated SINR of each of the precoding vectors; and

a feeding back unit configured to feed back to a base station a PMI of the selected precoding vector and a quantified value of the corresponding SINR, or feed back to a base station a PMI of the selected precoding vector, a quantified value of the corresponding SINR and a number of times of transformation to which the SINR corresponds, or feed back to a base station a number of times of transformation to which the SINR corresponds.

According to a further aspect of the embodiments of the present invention, there is provided a base station, comprising:

a receiving unit configured to receive information fed back by a plurality of users, the information fed back by a plurality of users including: a PMI of a precoding vector and a quantified value of the SINR of the precoding vector for each user, or a PMI of a precoding vector, a quantified value of the SINR of the precoding vector and information about a number of times of transformation to which the SINR corresponds for each user, or the number of times of transformation of the precoding matrix for each user; and

a selecting unit configured to select, according to the information received by the receiving unit and fed back by the plurality of users, a predetermined number of users which perform the same number of times of transformation on the original precoding matrix and satisfy user pairing conditions, as selected users.

According to still another aspect of the embodiments of the present invention, there is provided a computer-readable program, wherein when the program is executed in user equipment, the program enables the computer to carry out the method for selecting multi-user pairing in an MU-MIMO system as described above in the user equipment.

According to still another aspect of the embodiments of the present invention, there is provided a storage medium in which a computer-readable program is stored, wherein the computer-readable program enables the computer to carry out the method for selecting multi-user pairing in an MU-MIMO system as described above in user equipment.

According to still another aspect of the embodiments of the present invention, there is provided a computer-readable program, wherein when the program is executed in a base station, the program enables the computer to carry out the method for selecting multi-user pairing in an MU-MIMO system as described above in the base station.

According to still another aspect of the embodiments of the present invention, there is provided a storage medium in which a computer-readable program is stored, wherein the computer-readable program enables the computer to carry out the method for selecting multi-user pairing in an MU-MIMO system as described above in a base station.

The advantages of the embodiments of the present invention exist in that the user equipment searches precoding vectors in a precoding matrix to which the maximum SINR corresponds, and feeds back the information to which the selected precoding vectors correspond, such as a PMI of the precoding vectors and a corresponding SINR, or a PMI of the precoding vectors, a corresponding SINR and a corresponding number of times of transformation, or a number of times of transformation to which the precoding vectors correspond, to a base station, so that the base station may select multi-user pairing according to the feedback information of the user equipment based on the SINR, and fulfill scheduling of the MU-MIMO, thereby improving performances when the number of users is relatively small or the SINR is relatively low.

With reference to the following description and drawings, the particular embodiments of the present invention are disclosed in detail, and the principle of the present invention and the manners of use are indicated. It should be understood that the scope of the embodiments of the present invention is not limited thereto. The embodiments of the present invention contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the present invention can be better understood with reference to the following drawings. The components in the drawings are not necessarily to scale, emphasis instead being placed upon clearly illustrating the principles of the present invention. To facilitate illustrating and describing some parts of the invention, corresponding portions of the drawings may be enlarged or reduced. Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment. In the drawings:

FIG. 1 is a flowchart of the method for selecting multi-user pairing in an MU-MIMO system of Embodiment 1 of the present invention;

FIG. 2 is a flowchart of the method for selecting multi-user pairing in an MU-MIMO system of Embodiment 2 of the present invention;

FIG. 3 is a flowchart of the method for selecting of an embodiment in FIG. 2;

FIG. 4 is flowchart of selecting multiple users from users based on the original precoding matrix of the embodiment of FIG. 3;

FIG. 5 is a flowchart of the method for selecting of another embodiment in FIG. 2;

FIG. 6 is a schematic diagram of the composition of the user equipment of Embodiment 3 of the present invention; and

FIG. 7 is a schematic diagram of the composition of the base station of Embodiment 4 of the present invention.

### DETAILED DESCRIPTION OF THE INVENTION

The foregoing and other features of the embodiments of the present invention will become apparent with reference to the drawings and the following description. These embodiments are illustrative only and are not intended to limit the present invention.

### Embodiment 1

FIG. 1 is a flowchart of the method for selecting multi-user pairing in an MU-MIMO system of Embodiment 1 of the present invention. As shown in FIG. 1, the method comprises:

step 101: calculating by user equipment an SINR (signal to interference plus noise ratio) of each of precoding vectors in a precoding matrix;

step 102: selecting by the user equipment a precoding vector to which an SINR greater than a first predetermined threshold corresponds according to the calculated SINR of each of precoding vectors; and

step 103: feeding back by the user equipment to a base station a PMI (precoding matrix indicator) of the selected precoding vector and a quantified value of the corresponding SINR, or feeding back by the user equipment to a base station a PMI of the selected precoding vector, a quantified value of the corresponding SINR and a number of times of transformation to which the SINR corresponds, or feeding back by the user equipment to a base station a number of times of transformation to which the SINR corresponds.

Before step 101, the user equipment performs channel estimation, the detailed method of channel estimation being realized by means of the prior art and omitted herein.

In step 101, the precoding matrix may be an original precoding matrix, and may also be a transformed precoding matrix.

If the SINR of the precoding vectors in the original precoding matrix is calculated in step 101, in step 103, the user equipment feeds back a PMI of the selected precoding vector and a quantified value of the corresponding SINR to the base station, so that the base station selects multi-user pairing and allocates resources by scheduling users based on the original precoding matrix in the users feeding back the above information, which shall be described in detail in the following embodiment of base station side.

If the SINR of the precoding vectors in the transformed precoding matrix is calculated in step 101, in step 103, the user equipment may feed back a PMI of the selected precoding vector, a quantified value of the corresponding SINR and a number of times of transformation to which the SINR corresponds to the base station, may feed back a number of times of transformation to which the SINR corresponds to the base station, and may feed back a PMI of the selected precoding vector and a quantified value of the corresponding SINR to the base station.

In case that the user equipment feeds back the PMI, the SINR and the number of times of transformation, the base station selects multi-user pairing and allocates resources by scheduling users having the same number of times of transformation in the users feeding back the above information, which shall be described in detail in the following embodiment of base station side.

In case that the user equipment feeds back only the number of times of transformation, if the base station does not finish resource allocation by scheduling users based on the original precoding matrix in the users feeding back the above information (called as feedback users or fed back users in the embodiment of the present invention), the base station will issue indication of number of times of transformation according to a pairing policy of itself. After receiving the indication, the user equipment transforms its current precoding matrix according to the indicated number of times of transformation, and executes step 101. In case that a precoding vector to which an SINR greater than a first predetermined threshold corresponds is selected according to step 102, the user equipment feeds back only a PMI of the selected precoding vector and a quantified value of the corresponding SINR to the base station, but does not feed back number of times of transformation.

In this embodiment, step 102 may comprise the following steps:

step 1021: judging by the user equipment whether there is an SINR greater than the first threshold in the calculated SINRs of the precoding vectors, and executing step 1022 if yes; otherwise, executing step 1023;

step 1022: selecting a precoding vector to which the SINR greater than the first threshold corresponds by the user equipment according to a predefined policy, and executing step 103;

step 1023: transforming the precoding matrix by the user equipment by using a predefined transformation matrix, and proceeding to execute step 101.

In step 1023, the user equipment may judge whether the number of times of transformation of the precoding matrix reaches the maximum number of times of transformation, and if the maximum number of times of transformation is reached, the user equipment does not feed back information to the base station, so as to avoid unnecessary overhead; and if the maximum number of times of transformation is not reached, the user equipment may transform the precoding matrix by using the predefined transformation matrix.

Wherein, the maximum number of times of transformation may be set flexibly according to the complexity and performance requirements in implementation.

Wherein, the transformation of the precoding matrix by using a predefined transformation matrix may be pre-multiplication transformation, and may also be post-multiplication transformation, thereby obtaining transformed precoding matrix, and proceeding to execute step 101.

Wherein, the transformation matrix of this embodiment needs to satisfy that the characteristic direction of the precoding can be changed and the orthogonality of the transformed precoding matrix is ensured. Preferably, the transformation matrix is a unitary matrix or an orthogonal matrix, such as a rotation matrix, and a random unitary matrix, etc. For a rotation matrix, let the angle of one time of rotation to be θ, then the angle of two times of rotation is 2θ, and so on. And what is actually obtained by a random unitary matrix transformation is a new random precoding matrix. For example, a unitary matrix of primary diagonal values being relatively large and approximately equal and other values being relatively small is used as a transformation matrix, which is equivalent to that the precoding matrix is perturbed.

Following description is given to transforming the precoding matrix by using a predefined transformation matrix taking that the original precoding matrix and the transformation matrix are both unitary matrices as an example.

In this embodiment, assuming that the original precoding matrix is P, the transformation matrix is W and the new transformed precoding matrix is Q, the new transformed precoding matrix Q may be obtained by multiplying the original precoding matrix P by the transformation matrix W. Preferably, a new precoding matrix Q=WP may be obtained by the transformation matrix to perform pre-multiplication transformation on the original precoding matrix, and a new precoding matrix may also be obtained by the transformation matrix to perform post-multiplication transformation on the original precoding matrix. Wherein, the transformation matrix W needs to satisfy that there will exist no repeated result in a power of the matrix; that is, Wⁿ≠W^{m}, n≠m. In this embodiment, the transformation matrix may be equal to the precoding matrix.

Following description is given to the method of Embodiment 1 by way of an example. In this example, the precoding matrix P of MU-MIMO is a matrix containing L precoding vectors; where, L≦Mₜ, Mₜ is the number of transmission antennas of the base station; and according to the method of this embodiment:

each UE searches for an optimal vector in the precoding matrix P, so that the SINR is made to be maximum; and for the value of maximum SINR, if the SINR reaches a threshold, a PMI of the corresponding vector and the SINR result are reported; otherwise, the precoding matrix P is transformed, so as to obtain a new precoding matrix Q¹=WP. The UE searches for the precoding matrix Q¹ in the same manner, and for the value of maximum SINR, if the SINR reaches a threshold, a PMI of the corresponding vector and the SINR result are reported; otherwise, the precoding matrix Q¹ is transformed, Q²=WQ¹. And so on, until an SINR satisfying requirements is found.

Preferably, there are multiple original precoding matrices for an MU-MIMO system, such as P₁, P₂ . . . P_{M}. For M original precoding matrices, there may be one-to-one corresponding transformation matrices W₁, W₂ . . . W_{M}; and the transformation matrices may also be identical, that is, W₁=W₂= . . . W_{M}.

Preferably, in calculating the SINRs of the precoding vectors in the precoding matrix, the UE may also calculate interference to other UE(s) at the same time. In an embodiment, it is assumed that the current precoding matrix (the original precoding matrix or a transformed precoding matrix) has total L vectors, one (or several) of them Vᵢ being occupied by itself, and all the other vectors being allocated to other UE(s). The detailed method of calculation may be realized by means of the prior art, which is omitted herein. The above assumption is an example only, and in practical implementation, other conditions may also be assumed, and the embodiment is not limited thereto.

In the method of Embodiment 1, the UE searches the precoding vector to which the maximum SINR corresponds in the precoding matrix, and feeds the PMI of the vector and the SINR back to a base station, so that the base station determines a case of precoding transformation according to the feedback information, thereby selecting multi-user pairing and fulfilling scheduling of MU-MINO. Such a method of selecting multi-user pairing improves probability and performance of the pairing in a case of relatively small number of users.

An embodiment of the present invention further provides a method for selecting multi-user pairing in an MU-MINO system, as described in Embodiment 2 below.

### Embodiment 2

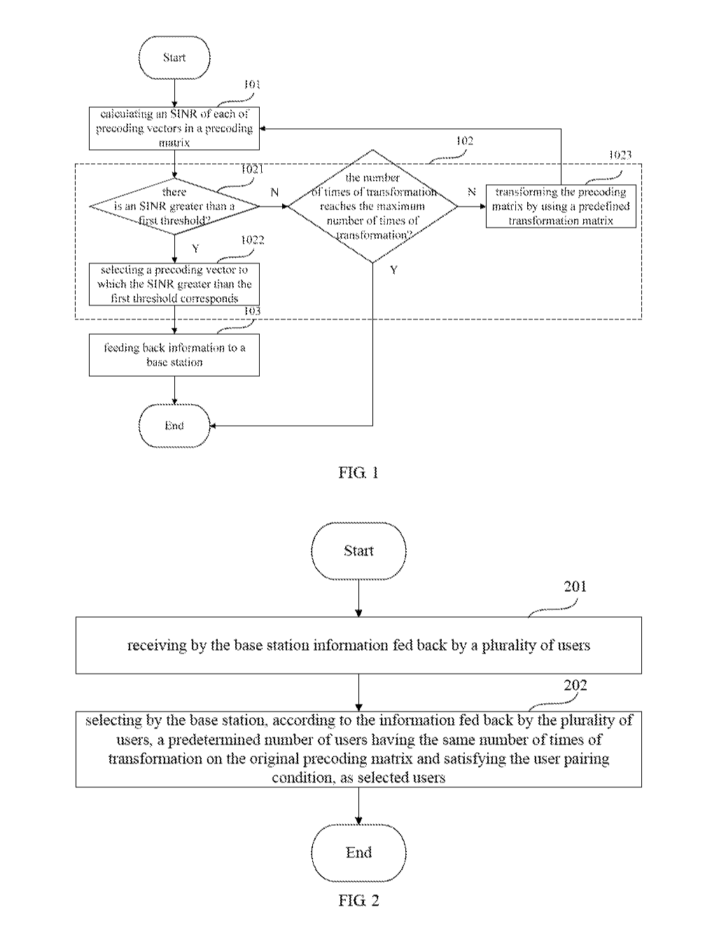

FIG. 2 is a flowchart of the method for selecting multi-user pairing in an MU-MIMO system of Embodiment 2 of the present invention. In the following description, a user pairing condition refers to that selected codewords fed back by UE belong to the same code group, and are located in different vectors; and an SINR condition refers to that a fed back SINR is greater than a first predefined threshold.

Referring to FIG. 2, the method comprises:

step 201: receiving by the base station information fed back by a plurality of users;

in an embodiment, according Embodiment 1, the information is fed back to the base station by the users based on original precoding matrices, and at this moment, the information received by the base station comprises a PMI of a precoding vector and a quantified value of the SINR of the precoding vector for each user;

in another embodiment, according Embodiment 1, the information is fed back to the base station by the users based on transformed precoding matrices, and at this moment, the information received by the base station comprises a PMI of a precoding vector, a quantified value of the SINR of the precoding vector and a number of times of transformation to which the SINR corresponds for each user, and may comprise only the number of times of transformation of the precoding matrix for each user;

step 202: selecting by the base station, according to the information fed back by the plurality of users, a predetermined number of users performing the same number of times of transformation on the original precoding matrix and satisfying the user pairing condition, as selected users.

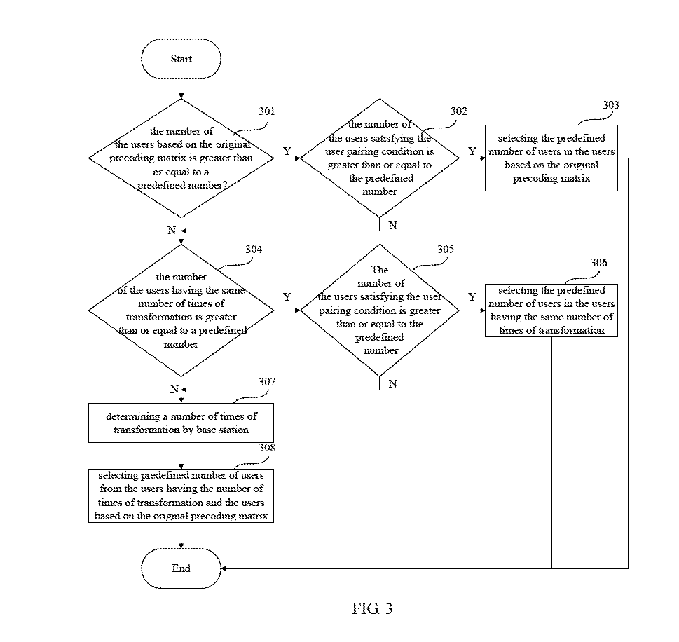

In this embodiment, the base station may select the predetermined number of users from the feedback users by using the method as shown in FIG. 3, or the method as shown in FIG. 5, which shall be described below respectively.

In the method shown in FIG. 3, the information received by the base station fed back by the plurality of users comprises a PMI of a precoding vector and a quantified value of the SINR of the precoding vector for each user, or a PMI of a precoding vector, a quantified value of the SINR of the precoding vector and a number of times of transformation to which the SINR corresponds for each user. In the embodiment shown in FIG. 3, the base station may finish the selection of the multi-user pairing without secondary interaction with the UE. Referring to FIG. 3, the method comprises:

step 301: judging by the base station whether the number of the users based on the original precoding matrix in the feedback users is greater than or equal to a predefined number, and executing step 302 if yes; otherwise, executing step 304;

step 302: judging by the base station whether the number of the users satisfying the user pairing condition in the users based on the original precoding matrix is greater than or equal to the predefined number, and executing step 303 if yes; otherwise, executing step 304;

step 303: selecting the predefined number of users satisfying the user pairing condition in the users based on the original precoding matrix as selected users;

in steps 301 and 302, if the results of judgment are no, it shows that the base station cannot select the needed predefined number of users from the users based on the original precoding matrix;

in steps 301 and 302, if the results of judgment are yes, the base station may select the needed predefined number of users from the users based on the original precoding matrix; hence, the base station needs only to schedule the users based on the original precoding matrix to fulfill allocation of resources, thereby fulfilling the scheduling of MU-MIMO;

with steps 301-303, in the feedback users, if the number of the users based on the original precoding matrix is greater than or equal to the predefined number and the number of the users satisfying the user pairing condition in the users based on the original precoding matrix is greater than or equal to the predefined number, the base station may select the predefined number of users satisfying the user pairing condition from the users based on the original precoding matrix as selected users;

step 304: judging by the base station whether the number of the users having the same number of times of transformation is greater than or equal to a predefined number, and executing step 305 if yes; otherwise, executing step 307;

step 305: judging by the base station whether the number of the users satisfying the user pairing condition in the users having the same number of times of transformation is greater than or equal to the predefined number, and executing step 306 if yes; otherwise, executing step 307;

step 306: selecting the predefined number of users satisfying the user pairing condition in the users having the same number of times of transformation as selected users;

in steps 304 and 305, if the results of judgment are no, it shows that the base station cannot select the needed predefined number of users from the users having the same number of times of transformation;

in steps 304 and 305, if the results of judgment are yes, the base station may select the needed predefined number of users from the users having the same number of times of transformation; hence, the base station needs only to schedule the users having the same number of times of transformation to fulfill allocation of resources, thereby fulfilling the scheduling of MU-MIMO;

with steps 304-306, in the feedback users, if the number of the users based on the original precoding matrix is less than the predefined number, the number of the users having the same number of times of transformation is greater than or equal to the predefined number and the number of the users satisfying the user pairing condition in the users having the same number of times of transformation is greater than or equal to the predefined number, the base station may select the predefined number of users satisfying the user pairing condition from the users having the same number of times of transformation as selected users;

step 307: determining a number of times of transformation by the base station; and

step 308: selecting by the base station the users satisfying the SINR condition and the user pairing condition from the users having the same number of times of transformation and the users based on the original precoding matrix, and selecting the predefined number of users as the selected users if the number of the selected users is greater than or equal to the predefined number;

wherein, in selecting the users satisfying the SINR condition and the user pairing condition from the users having the number of times of transformation by the base station, as the users having the number of times of transformation satisfy the SINR condition, users satisfying the user pairing condition may be selected from them;

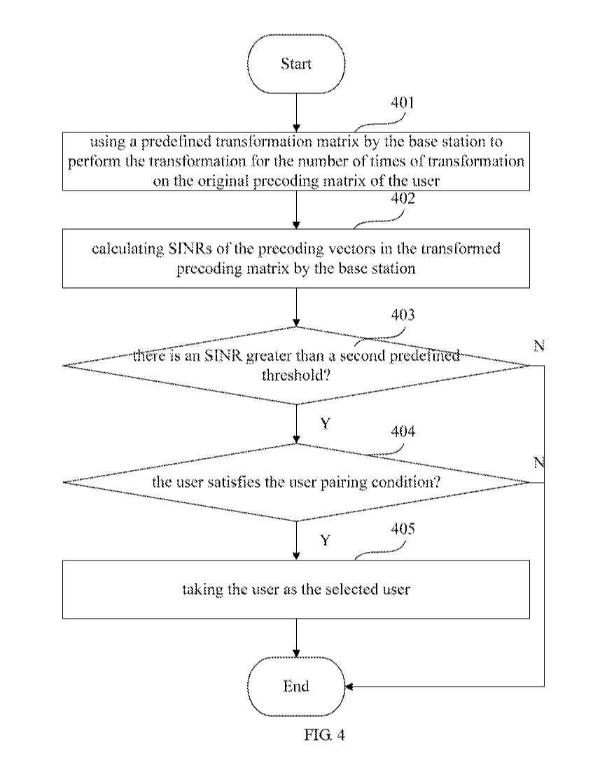

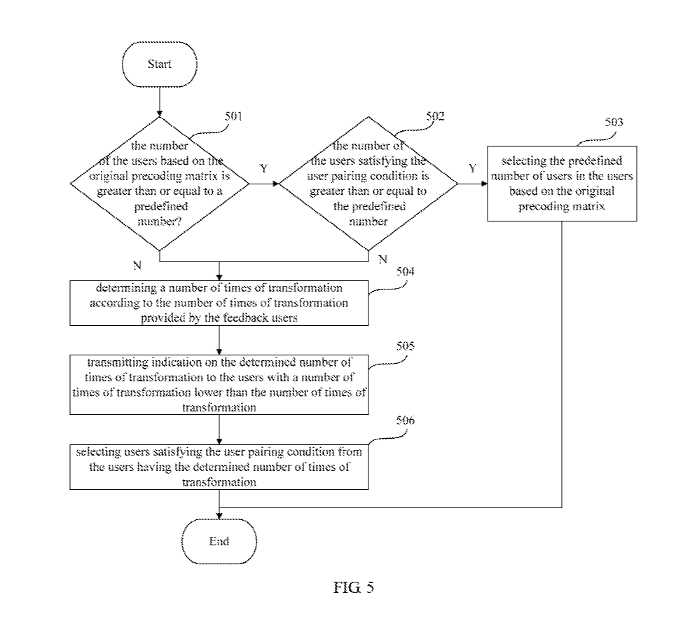

and wherein, the selecting by the base station the users satisfying the SINR condition and the user pairing condition from the users based on the original precoding matrix may be executed by using the method shown in FIG. 4.

Referring FIG. 4, the method comprises:

performing the following operations by the base station for each of the users based on the original precoding matrix, so as to determine whether to select the user, comprising:

step 401: using a predefined transformation matrix by the base station to perform the transformation for the number of times of transformation on the original precoding matrix of the user;

step 402: calculating SINRs of the precoding vectors in the transformed precoding matrix by the base station;

step 403: judging by the base station whether there is an SINR greater than a second predefined threshold in all the calculated SINRs, and executing step 404 if yes;

step 404: judging by the base station whether the user satisfies the user pairing condition, and executing step 405 if yes;

step 405: taking the user by the base station as the selected user.

In steps 403 and 404, if the results of judgment are no, the base station does not take the user as the selected user.

According to the method shown in FIG. 4, the base station may select the needed user from the users based on the original precoding matrix.

Wherein, if the results of judgment are no in steps 403 and 404, the base station cannot take the user as the selected user.

And wherein, the second predefined threshold may be identical to the first predefined threshold, and may also be a value obtained after the first predefined threshold is offset.

According to steps 307-308 and the method shown in FIG. 4, the base station selects users satisfying the SINR condition and the user pairing condition from the users having a determined number of times of transformation and the users based on the original precoding matrix. If the number of the selected users is greater than or equal to the predefined number needed by the base station, the base station may select the needed predefined number of users from them as the final selected users according to a predefined policy. And if the number of the selected users is less than the predefined number needed by the base station, the base station cannot select the predefined number of users. At this moment, the base station may redetermine a number of times of transformation according to the number of times of transformation to which the feedback users correspond, and perform reselection according to steps 307-308, and so on. If the number of times of transformation to which the feedback users correspond is used out, that is, the base station does not select suitable users after traversing all the corresponding number of times of transformation, the base station takes a result of user selection in the preceding process of allocation in which most users are allocated and the codewords of each user belong to the same code group and are located in different vector positions as the optimal result, takes a corresponding precoding matrix as a codebook group, and allocates the vectors with the same codewords as those fed back by the user to the user.

With steps 307-308, in the feedback users, if the number of the users based on the original precoding matrix is less than the predefined number and the number of the users having the same number of times of transformation is also less than the predefined number, the base station may determine a number of times of transformation, then select the users satisfying the SINR condition and the user pairing condition from the users having the number of times of transformation and the users based on the original precoding matrix, and select the predefined number of users from the selected users as the selected users if the number of the selected users is greater than or equal to the predefined number.

With the method shown in FIG. 3, the base station may fulfill the multi-user pairing according to the feedback information of the plurality of users, without secondary interaction with the users, thereby allocating resources and improving probability and performance of the pairing in a case of relatively small number of users.

In the method of selection shown in FIG. 5, the information received by the base station fed back by the plurality of users comprises a PMI of a precoding vector and a quantified value of the SINR of the precoding vector for each user, or comprises only the number of times of transformation of the precoding matrix for each user. In the embodiment shown in FIG. 5, if the base station selects no suitable multi-user pairing from the feedback users by scheduling the users based on the original precoding matrix, the base station needs to fulfill multi-user pairing selection by secondary interaction with the UE. Referring to FIG. 5, steps 501-503 are identical to steps 301-303, which are omitted herein. And the method further comprises:

step 504: determining a number of times of transformation by the base station according to the number of times of transformation provided by the feedback users;

step 505: transmitting indication on the determined number of times of transformation by the base station to the users with a number of times of transformation lower than the number of times of transformation; and

step 506: selecting users satisfying the user pairing condition from the users having the determined number of times of transformation by the base station according to the information re-fed back by the users with a number of times of transformation lower than the number of times of transformation.

According to steps 504-506, in the feedback users, after receiving the number of times of transformation transmitted by the base station, the users with a number of times of transformation lower than the number of times of transformation use a predefined transformation matrix to perform transform on the current precoding matrix for a corresponding number of times according to a preceding number of times of transformation of themselves (the detailed method of transformation is identical to that of Embodiment 1), and feed back corresponding information to the base station according to the method of Embodiment 1. At this moment, the users need only to feed back a PMI of a precoding vector and a quantified value of the corresponding SINR, so that the base station selects users satisfying the user pairing condition from the users with a number of times of transformation lower than the number of times of transformation according to the re-fed back information.

For example, it is assumed that the base station sends a number 3 of times of transformation to the feedback users with a number of times of transformation lower than 3. Wherein, for users without performing precoding matrix transformation before, after performing three times of transformation on their original precoding matrices, calculate SINR values of the precoding vectors in the transformed precoding matrices, select precoding vectors of SINRs greater than the first predefined threshold, and feed the PMIs of the precoding vectors and the quantified values of the SINRs back to the base station, so that the base station selects multi-user pairing. Wherein, for users having been performing precoding matrix transformation once before, after performing two times of transformation on their transformed precoding matrices, calculate SINR values of the precoding vectors in the transformed precoding matrices, select precoding vectors of SINRs greater than the first predefined threshold, and feed the PMIs of the precoding vectors and the quantified values of the SINRs back to the base station, so that the base station selects multi-user pairing. Wherein, for users having been performing precoding matrix transformation twice before, after performing transformation on their transformed precoding matrices once, calculate SINR values of the precoding vectors in the transformed precoding matrices, select precoding vectors of SINRs greater than the first predefined threshold, and feed the PMIs of the precoding vectors and the quantified values of the SINRs back to the base station, so that the base station selects multi-user pairing.

What is described above is an example only. In detailed implementation, the base station may also transmit the number of times of transformation to the users having fixed number of times of transformation only; for example, the number of times of transformation is transmitted to the users based on the original precoding matrix in the feedback users only.

According to steps 504-506, the base station selects users satisfying the SINR condition and the user pairing condition from the users (including the users in the first time of feedback and the users in the second time of feedback) having a determined number of times of transformation. If the number of the selected users is greater than or equal to the predefined number needed by the base station, the base station may select the needed predefined number of users from them as the final selected users according to a predefined policy. And if the number of the selected users is less than the predefined number needed by the base station, the base station cannot select the predefined number of users. At this moment, the base station may redetermine a number of times of transformation and perform reselection, with the detailed method of selection being the same as that of steps 504-506, and so on. If the number of times of transformation to which the feedback users correspond is used out, that is, the base station does not select suitable users after traversing all the number of times of transformation in the first time of feedback, the base station takes a result of user selection in the preceding process of allocation in which most users are allocated and the codewords of each user belong to the same code group and are located in different vector positions as the optimal result, takes a corresponding precoding matrix as a codebook group, and allocates the vectors with the same codewords as those fed back by the user to the user.

With steps 504-506, in the feedback users, if the number of the users based on the original precoding matrix is less than the predefined number, the base station may determine a number of times of transformation, inform the determined number of times of transformation to the users with a number of times of transformation less than the number of times of transformation, then select the users satisfying the user pairing condition according to the information re-fed back by the users, and select the predefined number of users from the selected users as the selected users if the number of the selected users is greater than or equal to the predefined number.

In Embodiment 2, the method of performing transformation on the precoding matrix by the base station is identical to the method of performing transformation on the precoding matrix by the user equipment in Embodiment 1, which is omitted herein.

Following description is given to the method of Embodiment 2 by way of an example. In this example, the base station determines a case of precoding transformation according to feedback information. If in the information fed back by the plurality of users, the resource allocation is fulfilled by scheduling the users based on the original precoding matrix, the precoding matrix is not transformed, and no information interaction is performed with the users, while the resource allocation is performed by using the current precoding matrix and the users are informed, thereby fulfilling scheduling of MU-MIMO; and if all the resources cannot be allocated by scheduling the users based on the original precoding matrix, the base station transforms the precoding matrix and selects multi-user pairing according to the transformation values of largest identical number of times of transformation in the information fed back by the plurality of users, or according to the transformation values of smallest number of times of transformation in the information fed back by the plurality of users, or according to other policies, or notifies the users to re-feed back information after performing transformation for the transformation values on their current precoding matrices, and select the multi-user pairing according to the information re-fed back by the users.

Preferably, the base station performs pairing and resource allocation for users from all the feedback users. Assuming that the base station supports at most L paths of data transmission and codewords belonging to the same code group fed back by L users and located in L different vectors may be found in the feedback users, that is, the user pairing condition is satisfied, it is considered that the base station fulfills resource allocation of MU-MIMO. That is, for the paired users, the fed back precoding matrix/vector Vᵢ satisfies [Vᵢ_{₁} Vᵢ_{₂} . . . Vᵢ_{_{L}}]=P or [Vᵢ_{₁} Vᵢ_{₂} . . . Vᵢ_{_{L}}]=Q^{j}.

Preferably, if the base station cannot fulfill the resource allocation by scheduling the users based on the original precoding matrix, and cannot fulfill the resource allocation by scheduling the users having the same number of times of transformation, the base station may transform the precoding matrix, and select the users satisfying the SINR condition and the user pairing condition after the transformation. Wherein, the number of times of transformation may be determined according to the instructions of the users. For example, for the transformed users, if the numbers of times of transformation instructed by the users are 3, 2, 3, 3, 4, respectively, the base station may perform three times of transformation on the precoding matrix according to the transformation values of the largest identical number of times of transformation, such as 3, and may perform two times of transformation on the precoding matrix according to the transformation values of the smallest number of times of transformation, such as 2, so as to perform pairing and resource allocation for the users having the identical numbers of times of transformation.

Preferably, the base station may, through instructions, make the users having a number of times of transformation less than 3 to transform the current precoding matrix, and to feed back corresponding information after reaching 3 times of transformation. And the base station may perform pairing and resource allocation for the users having 3 times of transformation according to the feedback information.

Wherein, performing pairing and resource allocation for the users having the identical numbers of times of transformation may satisfy the orthogonality between the codebooks.

Wherein, if the base station still cannot select the users that codewords fed back by L users belonging to the same code group and located in L different vectors when the number of times of transformation on the precoding matrix by the base station reaches the maximum number of times of transformation, the base station takes a result of user selection in the preceding process of allocation in which most users are allocated and the codewords of each user belong to the same code group and are located in different vector positions as the optimal result, takes a corresponding precoding matrix as a codebook group, and allocates the vectors with the same codewords as those fed back by the user to the user.

According to the method of this embodiment, the base station may notify the users after performing the selection of multi-user pairing and resource allocation.

In the method of Embodiment 2, the base station determines a case of precoding transformation according to fed back information, and fulfills user pairing and resource allocation by scheduling the users having the same number of times of transformation in the information fed back by the plurality of users, thereby lowering the complexity and ensuring the performance of the system.

An embodiment of the present invention further provides UE, as described in Embodiment 3 below. As the principle of the UE for solving problems is similar to that of the method of Embodiment 1, the implementation of the method of Embodiment 1 may be referred to for the implementation of the UE, and the repeated parts shall not be described any further.

### Embodiment 3

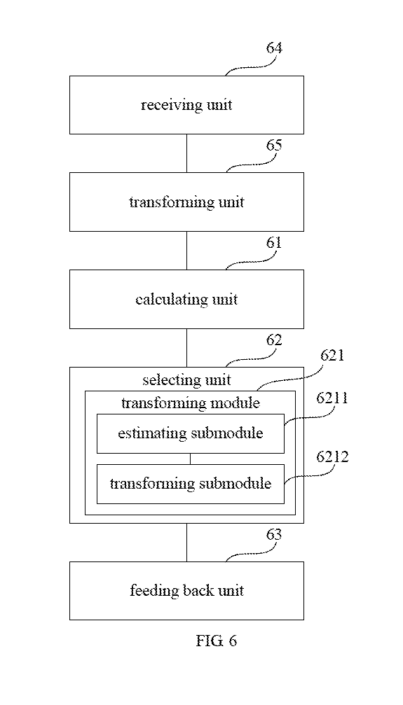

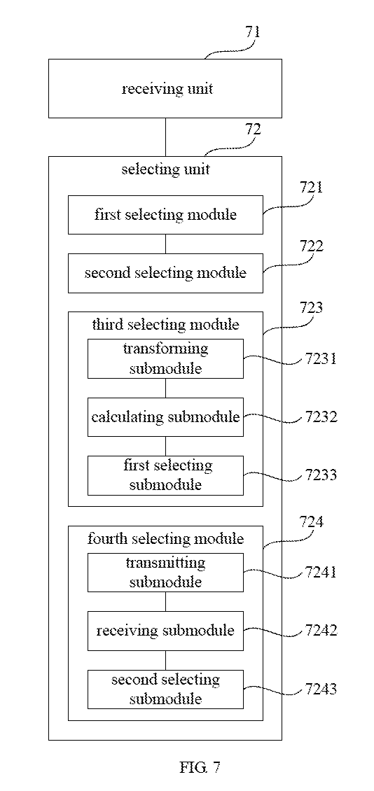

FIG. 6 is a schematic diagram of the composition of the UE of Embodiment 3 of the present invention. As shown in FIG. 6, the UE comprises:

a calculating unit 61 configured to calculate an SINR of each of precoding vectors in a precoding matrix;

a selecting unit 62 configured to select a precoding vector to which an SINR greater than a first predetermined threshold corresponds according to the calculated SINR of each of the precoding vectors; and

a feeding back unit 63 configured to feed back to a base station a PMI of the selected precoding vector and a quantified value of the corresponding SINR, or feed back to a base station a PMI of the selected precoding vector, a quantified value of the corresponding SINR and a number of times of transformation to which the SINR corresponds, or feed back to a base station a number of times of transformation to which the SINR corresponds.

In an embodiment, the selecting unit 62 comprises:

a transforming module 621 configured to transform the precoding matrix by using a predetermined transformation matrix when there is no SINR in those SINRs calculated by the calculating unit that is greater than the first predetermined threshold, so that the calculating unit calculates the SINR of each precoding vector in the transformed precoding matrix.

Wherein, the transforming module 621 comprises:

an estimating submodule 6211 configured to estimate whether the number of times of transformation of the precoding matrix reaches a maximum number of times of transformation; and

a transforming submodule 6212 configured to transform the precoding matrix by using the predetermined transformation matrix if it is estimated by the estimating submodule that the number of times of transformation of the precoding matrix does not reach a maximum number of times of transformation.

In another embodiment, the UE further comprises:

a receiving unit 64 configured to receive an instruction of the number of times of transformation transmitted by the base station after the feeding back unit 62 feeds back the number of times of transformation on the precoding matrix to the base station; and

a transforming unit 65 configured to transform the current precoding matrix according to the instruction received by the receiving unit 64, so as to reaches the instructed number of times of transformation, so that the calculating unit calculates the SINR of each precoding vector in the transformed precoding matrix, and the feeding back unit 63 further feeds back to the base station the PMI of the selected precoding vector and the quantified value of the corresponding SINR further selected by the selecting unit 62.

The UE of this embodiment searches for precoding vectors to which the maximum SINR corresponds in the precoding matrix, and feeds the PMIs of the vectors and the SINR back to the base station, or feeds back the number of times of transformation at the same time, or feeds back only the number of times of transformation, so that the base station determines a case of precoding transformation according to the fed back information, thereby selecting multi-user pairing, fulfilling scheduling of MU-MIMO, and improving the performance when the number of users is relatively small or the SNR is relatively low.

An embodiment of the present invention further provides a base station, as described in Embodiment 4 below. As the principle of the base station for solving problems is similar to that of the method of Embodiment 2, the implementation of the method of Embodiment 2 may be referred to for the implementation of the base station, and the repeated parts shall not be described any further.

### Embodiment 4

FIG. 7 is a schematic diagram of the composition of the base station of Embodiment 4 of the present invention. As shown in FIG. 7, the base station comprises:

a receiving unit 71 configured to receive information fed back by a plurality of users, the information fed back by the plurality of users including: a PMI of a precoding vector and a quantified value of the SINR of the precoding vector for each user, or a PMI of a precoding vector, a quantified value of the SINR of the precoding vector and information about a number of times of transformation to which the SINR corresponds for each user, or the number of times of transformation of the precoding matrix for each user; and

a selecting unit 72 configured to select, according to the information received by the receiving unit and fed back by the plurality of users, a predetermined number of users which perform the same number of times of transformation on the original precoding matrix and satisfy user pairing conditions, as selected users.

In an embodiment, the selecting unit 72 comprises:

a first selecting module 721 configured to select from users based on the original precoding matrix, a predetermined number of users satisfying the user pairing conditions as the selected users, when the number of the users based on the original precoding matrix among the plurality of users is greater than or equal to the predetermined number and the number of the users satisfying the user pairing conditions among the users based on the original precoding matrix is greater than or equal to the predetermined number.

In another embodiment, the selecting unit 72 comprises:

a second selecting module 722 configured to select from users having the same number of times of transformation, a predetermined number of users satisfying the user pairing conditions as the selected users, when the number of the users based on the original precoding matrix among the plurality of users is less than the predetermined number, the number of the users having the same number of times of transformation is greater than or equal to the predetermined number and the number of the users satisfying the user pairing conditions among the users having the same number of times of transformation is greater than or equal to the predetermined number.

In still another embodiment, the selecting unit 72 comprises:

a third selecting module 723 configured to determine a first number of times of transformation when the number of the users based on the original precoding matrix among the plurality of users is less than the predetermined number and the number of the users having the same number of times of transformation is also less than the predetermined number, and to select users satisfying an SINR condition and the user pairing conditions from the users having the first number of times of transformation and from the users based on the original precoding matrix, and select a predetermined number of users from the selected users as the selected users if the number of the selected users is greater than or equal to the predetermined number.

Wherein, the third selecting module 723 comprises:

a transforming submodule 7231 configured to perform, for each of the users based on the original precoding matrix among fed back users, the first number of times of transformation on the original precoding matrix of the users by using a preconfigured transformation matrix;

a calculating submodule 7232 configured to calculate the SINR of each precoding vector in the precoding matrix transformed by the transforming submodule 7231; and

a first selecting submodule 7233 configured to select a user as the user satisfying the SINR condition and the user pairing conditions if there is an SINR in all those SINRs calculated by the calculating submodule 7232 that is greater than a second predetermined threshold and the user to which the SINR greater than the second predetermined threshold corresponds satisfies the user pairing conditions.

In further still another embodiment, the selecting unit 72 comprises:

a fourth selecting module 724 configured to determine a second number of times of transformation when the number of the users based on the original precoding matrix among the plurality of users is less than the predetermined number, and select users satisfying an SINR condition and the user pairing conditions from the users having less than the number of times of transformation, and select a predetermined number of users from the selected users as the selected users if the number of the selected users is greater than or equal to the predetermined number.

Wherein, the fourth selecting module 724 comprises:

a transmitting submodule 7241 configured to transmit the second number of times of transformation to the users among the fed back users that fed back performing the number of times of transformation on the precoding matrix less than the second number of times of transformation;

a receiving submodule 7242 configured to receive the information fed back again by the users of which the number of times of transformation on the precoding matrix is less than the second number of times of transformation; and

a second selecting submodule 7243 configured to select the users satisfying the user pairing conditions according to the information that is fed back again.

The base station of this embodiment determines a case of precoding transformation according to PMI's of vectors and an SINR fed back by the UE by searching for precoding vectors to which the maximum SINR corresponds in the precoding matrix, thereby selecting multi-user pairing, fulfilling scheduling of MU-MIMO, and improving the performance when the number of users is relatively small or the SNR is relatively low.

An embodiment of the present invention further provides a computer-readable program, wherein when the program is executed in UE, the program enables the computer to carry out the method for selecting multi-user pairing in an MU-MIMO system as described in Embodiment 1 in the UE.

An embodiment of the present invention further provides a storage medium in which a computer-readable program is stored, wherein the method for selecting multi-user pairing in an MU-MIMO system as described in Embodiment 1 in UE.

An embodiment of the present invention further provides a storage medium in which a computer-readable program, wherein when the program is executed in a base station, the program enables the computer to carry out the method for selecting multi-user pairing in an MU-MIMO system as described in Embodiment 2 in the base station.

An embodiment of the present invention further provides a storage medium in which a computer-readable program is stored, wherein the method for selecting multi-user pairing in an MU-MIMO system as described in Embodiment 2 in a base station.

The above apparatuses and methods of the present invention may be implemented by hardware, or by hardware in combination with software. The present invention relates to such a computer-readable program that when the program is executed by a logic device, the logic device is enabled to carry out the apparatus or components as described above, or to carry out the methods or steps as described above. The present invention also relates to a storage medium for storing the above program, such as a hard disk, a floppy disk, a CD, a DVD, and a flash memory, etc.

The present invention is described above with reference to particular embodiments. However, it should be understood by those skilled in the art that such a description is illustrative only, and not intended to limit the protection scope of the present invention. Various variants and modifications may be made by those skilled in the art according to the spirits and principle of the present invention, and such variants and modifications fall within the scope of the present invention.

1. A method for selecting multi-user pairing in a multi-user multi-input multi-output system, comprising:
calculating by user equipment an SINR (signal to interference plus noise ratio) of each of precoding vectors in a precoding matrix;
selecting by the user equipment a precoding vector to which an SINR greater than a first predetermined threshold corresponds according to the calculated SINR of each of the precoding vectors; and
feeding back by the user equipment to a base station a PMI (precoding matrix indicator) of the selected precoding vector and a quantified value of the corresponding SINR, or feeding back by the user equipment to a base station a PMI of the selected precoding vector, a quantified value of the corresponding SINR and a number of times of transformation to which the SINR corresponds, or feeding back by the user equipment to a base station a number of times of transformation to which the SINR corresponds.

2. The method according to claim 1, if there is no SINR in the calculated SINR that is greater than the first predetermined threshold, the method further comprises:
transforming by the user equipment the precoding matrix by using a predetermined transformation matrix, and proceeding to execute the calculating step.

3. The method according to claim 2 further comprises:
estimating whether the number of times of transformation of the precoding matrix reaches a maximum number of times of transformation; and
transforming by the user equipment the precoding matrix by using the predetermined transformation matrix if the number of times of transformation of the precoding matrix does not reach a maximum number of times of transformation.

4. The method according to claim 2 further comprises:
performing premultiplication transformation or postmultiplication transformation on the precoding matrix by using the predetermined transformation matrix to obtain the transformed precoding matrix.

5. The method according to claim 1, if the user equipment feeds back the number of times of transformation on the precoding matrix to the base station, the method further comprises:
receiving by the user equipment an instruction of the number of times of transformation transmitted by the base station; and
transforming the current precoding matrix by the user equipment according to the instruction so that the number of times of transformation reaches the instructed number of times of transformation, executing the calculating step, and feeding back to the base station in the feeding back step the PMI of the selected precoding vector and the quantified value of the corresponding SINR.

6. A method for selecting multi-user pairing in a multi-user multi-input multi-output system, comprising:
receiving by a base station information fed back by a plurality of users, the information fed back by the plurality of users including: a PMI of a precoding vector and a quantified value of the SINR of the precoding vector for each user, or a PMI of a precoding vector, a quantified value of the SINR of the precoding vector and information about a number of times of transformation to which the SINR corresponds for each user, or the number of times of transformation of the precoding matrix for each user; and
selecting by the base station, according to the information fed back by the plurality of users, a predetermined number of users having the same number of times of transformation on the original precoding matrix and satisfying user pairing conditions, as selected users.

7. The method according to claim 6 further comprises:
selecting from users based on the original precoding matrix, a predetermined number of users satisfying the user pairing conditions as the selected users, when the number of the users based on the original precoding matrix among the plurality of users is greater than or equal to a predetermined number and the number of the users satisfying the user pairing conditions among the users based on the original precoding matrix is greater than or equal to the predetermined number.

8. The method according to claim 6 further comprises:
selecting from users having the same number of times of transformation, a predetermined number of users satisfying the user pairing conditions as the selected users, when the number of the users based on the original precoding matrix among the plurality of users is less than a predetermined number, the number of the users having the same number of times of transformation is greater than or equal to the predetermined number and the number of the users satisfying the user pairing conditions among the users having the same number of times of transformation is greater than or equal to the predetermined number.

9. The method according to claim 6 further comprises:
determining by the base station a first number of times of transformation when the number of the users based on the original precoding matrix among the plurality of users is less than the predetermined number and the number of the users having the same number of times of transformation is also less than the predetermined number, and selecting users satisfying an SINR condition and the user pairing conditions, from the users having the first number of times of transformation and from the users based on the original precoding matrix, and selecting a predetermined number of users from the selected users as the selected users if the number of the selected users is greater than or equal to the predetermined number.

10. The method according to claim 9 further comprises:
for each of the users based on the original precoding matrix among fed back users;
performing by the base station the first number of times of transformation on the original precoding matrix of the users by using a preconfigured transformation matrix;
calculating by the base station the SINR of each precoding vector in the transformed precoding matrix; and
selecting by the base station a user as the user satisfying the SINR condition and the user pairing conditions if there is an SINR in all those calculated SINRs that is greater than a second predetermined threshold and the user to which the SINR greater than the second predetermined threshold corresponds satisfies the user pairing conditions.

11. The method according to claim 6 further comprises:
determining by the base station a second number of times of transformation when the number of the users based on the original precoding matrix among the plurality of users is less than the predetermined number, and selecting users satisfying an SINR condition and the user pairing conditions from the users performing less than the second number of times of transformation, and selecting a predetermined number of users from the selected users as the selected users if the number of the selected users is greater than or equal to the predetermined number.

12. The method according to claim 11 further comprises:
transmitting by the base station the second number of times of transformation to the users among the fed back users performing number of times of transformation on the precoding matrix less than the second number of times of transformation;
receiving by the base station the information fed back again by the users of which the number of times of transformation on the precoding matrix is less than the second number of times of transformation; and
selecting by the base station the users satisfying the user pairing conditions according to the information that is fed back again.

13. User equipment, comprising:
a calculating unit configured to calculate an SINR of each of precoding vectors in a precoding matrix;
a selecting unit configured to select a precoding vector to which an SINR greater than a first predetermined threshold corresponds according to the calculated SINR of each of the precoding vectors; and
a feeding back unit configured to feed back to a base station a PMI of the selected precoding vector and a quantified value of the corresponding SINR, or feed back to a base station a PMI of the selected precoding vector, a quantified value of the corresponding SINR and a number of times of transformation to which the SINR corresponds, or feed back to a base station a number of times of transformation to which the SINR corresponds.

14. The user equipment according to claim 13, wherein the selecting unit comprises:
a transforming module configured to transform the precoding matrix by using a predetermined transformation matrix when there is no SINR in those SINRs calculated by the calculating unit that is greater than the first predetermined threshold, so that the calculating unit calculates the SINR of each precoding vector in the transformed precoding matrix.

15. The user equipment according to claim 13, wherein the user equipment further comprises:
a receiving unit configured to receive an instruction of the number of times of transformation transmitted by the base station after the feeding back unit feeds back the number of times of transformation on the precoding matrix to the base station; and
a transforming unit configured to transform the current precoding matrix according to the instruction received by the receiving unit, so as to reaches the instructed number of times of transformation, so that the calculating unit calculates the SINR of each precoding vector in the transformed precoding matrix, and the feeding back unit further feeds back to the base station the selected PMI of the selected precoding vector and the quantified value of the corresponding SINR.

16. A base station, comprising:
a receiving unit configured to receive information fed back by a plurality of users, the information fed back by the plurality of users including: a PMI of a precoding vector and a quantified value of the SINR of the precoding vector for each user, or a PMI of a precoding vector, a quantified value of the SINR of the precoding vector and information about a number of times of transformation to which the SINR corresponds for each user, or the number of times of transformation of the precoding matrix for each user; and
a selecting unit configured to select, according to the information received by the receiving unit and fed back by the plurality of users, a predetermined number of users which have the same number of times of transformation on the original precoding matrix and satisfy user pairing conditions, as selected users.

17. The base station according to claim 16, wherein the selecting unit comprises:
a first selecting module configured to select from users based on the original precoding matrix, a predetermined number of users satisfying the user pairing conditions as the selected users, when the number of the users based on the original precoding matrix among the plurality of users is greater than or equal to the predetermined number and the number of the users satisfying the user pairing conditions among the users based on the original precoding matrix is greater than or equal to the predetermined number.

18. The base station according to claim 16, wherein the selecting unit comprises:
a second selecting module configured to select from users having the same number of times of transformation, a predetermined number of users satisfying the user pairing conditions as the selected users, when the number of the users based on the original precoding matrix among the plurality of users is less than the predetermined number, the number of the users having the same number of times of transformation is greater than or equal to the predetermined number and the number of the users satisfying the user pairing conditions among the users having the same number of times of transformation is greater than or equal to the predetermined number.

19. The base station according to claim 16, wherein the selecting unit comprises:
a third selecting module configured to determine a first number of times of transformation when the number of the users based on the original precoding matrix among the plurality of users is less than the predetermined number and the number of the users having the same number of times of transformation is also less than the predetermined number, and to select users satisfying an SINR condition and the user pairing conditions from the users having the first number of times of transformation and from the users based on the original precoding matrix, and select a predetermined number of users from the selected users as the selected users if the number of the selected users is greater than or equal to the predetermined number.

20. The base station according to claim 16, wherein the selecting unit comprises:
a fourth selecting module configured to determine a second number of times of transformation when the number of the users based on the original precoding matrix among the plurality of users is less than the predetermined number, and select users satisfying an SINR condition and the user pairing conditions from the users performing less than the second number of times of transformation, and select a predetermined number of users from the selected users as the selected users if the number of the selected users is greater than or equal to the predetermined number.
